(19) United States
(12) Patent Application Publication
(10) Pub. No.: US 2021/0055419 A1
(43) Pub. Date: Feb. 25, 2021

(54) Depth sensor with interlaced sampling structure

(71) Applicant: Apple Inc., Cupertino, CA (US)

(72) Inventors: Thierry Oggier, San Jose, CA (US); Andrew T. Herrington, San Francisco, CA (US); Bernhard Buettgen, San Jose, CA (US)

(21) Appl. No.: 16/914,513

(22) Filed: Jun. 29, 2020

Related U.S. Application Data
(60) Provisional application No. 62/889,067, filed on Aug. 20, 2019.

(51) Int. Cl. G01S 17/894; G06T 7/50; G01S 17/06

(52) U.S. Cl. CPC G01S 17/894; G01S 17/06; G06T 7/50

(57) ABSTRACT

Apparatus for optical sensing includes an illumination assembly, which directs optical radiation toward a target scene while modulating the optical radiation with a carrier wave having a predetermined carrier frequency. A detection assembly includes an array of sensing elements, which output respective signals in response to the optical radiation that is incident on the sensing elements during each of a plurality of detection intervals, which are synchronized with the carrier frequency at different, respective temporal phase angles, and objective optics, which form an image of the target scene on the array. Processing circuitry processes the signals output by the sensing elements in order to compute depth coordinates of the points in the target scene by combining the signals output by respective groups of more than four of the sensing elements.

### CROSS-REFERENCE TO RELATED APPLICATION

This application claims the benefit of U.S. Provisional Patent Application 62/889,067, filed Aug. 20, 2019, which is incorporated herein by reference.

### FIELD OF THE INVENTION

The present invention relates generally to depth mapping, and particularly to methods and apparatus for depth mapping using indirect time of flight techniques.

### BACKGROUND

Various methods are known in the art for optical depth mapping, i.e., generating a three-dimensional (3D) profile of the surface of an object by processing an optical image of the object. This sort of 3D profile is also referred to as a 3D map, depth map or depth image, and depth mapping is also referred to as 3D mapping. (In the context of the present description and in the claims, the terms “optical radiation” and “light” are used interchangeably to refer to electromagnetic radiation in any of the visible, infrared and ultraviolet ranges of the spectrum.)

Some depth mapping systems operate by measuring the time of flight (TOF) of radiation to and from points in a target scene. In direct TOF (dTOF) systems, a light transmitter, such as a laser or array of lasers, directs short pulses of light toward the scene. A receiver, such as a sensitive, high-speed photodiode (for example, an avalanche photodiode) or an array of such photodiodes, receives the light returned from the scene. Processing circuitry measures the time delay between the transmitted and received light pulses at each point in the scene, which is indicative of the distance traveled by the light beam, and hence of the depth of the object at the point, and uses the depth data thus extracted in producing a 3D map of the scene

Indirect TOF (iTOF) systems, on the other hand, operate by modulating the amplitude of an outgoing beam of radiation at a certain carrier frequency, and then measuring the phase shift of that carrier wave (at the modulation carrier frequency) in the radiation that is reflected back from the target scene. The phase shift can be measured by imaging the scene onto an optical sensor array, and gating or modulating the integration times of the sensors in the array in synchronization with the modulation of the outgoing beam. The phase shift of the reflected radiation received from each point in the scene is indicative of the distance traveled by the radiation to and from that point, although the measurement may be ambiguous due to range-folding of the phase of the carrier wave over distance.

### SUMMARY

Embodiments of the present invention that are described hereinbelow provide improved apparatus and methods for depth mapping.

There is therefore provided, in accordance with an embodiment of the invention, apparatus for optical sensing, including an illumination assembly, which is configured to direct optical radiation toward a target scene while modulating the optical radiation with a carrier wave having a predetermined carrier frequency. A detection assembly is configured to receive the optical radiation that is reflected from the target scene, and includes an array of sensing elements, which are configured to output respective signals in response to the optical radiation that is incident on the sensing elements during each of a plurality of detection intervals, which are synchronized with the carrier frequency at different, respective temporal phase angles, and objective optics, which are configured to form an image of the target scene on the array. Processing circuitry is configured to process the signals output by the sensing elements in order to compute depth coordinates of the points in the target scene by combining the signals output by respective groups of more than four of the sensing elements.

In some embodiments, each of the sensing elements is configured to output the respective signals with respect to two different detection intervals within each cycle of the carrier wave. In one such embodiment, for each of the sensing elements, the respective temporal phase angles of the two different detection intervals are 180° apart and are shifted by 90° relative to a nearest neighboring sensing element in the array. Alternatively, the sensing elements are configured to output the respective signals with respect to detection intervals that are separated by 60° within each cycle of the carrier wave.

Typically, the processing circuitry is configured to calculate, over the sensing elements in each of the respective groups, respective sums of the signals output by the sensing elements due to the optical radiation in each of the detection intervals, and to compute the depth coordinates by applying a predefined function to the respective sums. Additionally or alternatively, the processing circuitry is further configured to generate a two-dimensional image of the target scene including a matrix of image pixels having respective pixel values corresponding to sums of the respective signals output by each of the sensing elements. In a disclosed embodiment, the respective groups include at least sixteen of the sensing elements.

In some embodiments, the processing circuitry is configured to adjust a number of the sensing elements in the groups. In one such embodiment, the processing circuitry is configured to adjust the number of the sensing elements in the groups responsively to the signals output by the sensing elements. The processing circuitry may be configured to detect a level of noise in the signals output by the sensing elements, and to modify the number of the sensing elements in the groups responsively to the level of the noise. Alternatively or additionally, the processing circuitry is configured to include different numbers of the sensing elements in the respective groups for different points in the target scene.

There is also provided, in accordance with an embodiment of the invention, a method for optical sensing, which includes directing optical radiation toward a target scene while modulating the optical radiation with a carrier wave having a predetermined carrier frequency. An image of the target scene is formed on an array of sensing elements, which output respective signals in response to the optical radiation that is incident on the sensing elements during each of a plurality of detection intervals, which are synchronized with the carrier frequency at different, respective temporal phase angles. The signals output by the sensing elements are processed in order to compute depth coordinates of the points in the target scene by combining the signals output by respective groups of more than four of the sensing elements.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a depth mapping apparatus, in accordance with an embodiment of the invention;

FIG. 2 is a schematic frontal view of an image sensor with an interlaced sampling structure, in accordance with an embodiment of the invention;

FIG. 3 is a block diagram that schematically shows details of sensing and processing circuits in a depth mapping apparatus, in accordance with an embodiment of the invention; and

FIG. 4 is a schematic frontal view of an image sensor with an interlaced sampling structure, in accordance with another embodiment of the invention.

### DETAILED DESCRIPTION OF EMBODIMENTS

Optical indirect TOF (iTOF) systems that are known in the art use multiple different acquisition phases in the receiver in order to measure the phase shift of the carrier wave in the light that is reflected from at each point in the target scene. For this purpose, many iTOF systems use special-purpose image sensing arrays, in which each sensing element is gated individually to receive and integrate light during a respective phase of the cycle of the carrier wave. At least three different gating phases are needed in order to measure the phase shift of the carrier wave in the received light relative to the transmitted beam. For practical reasons, most systems acquire light during four distinct gating phases.

In a typical image sensing array of this sort, the sensing elements are arranged in groups of four sensing elements (also referred to as “pixels”). Each sensing element in a given group integrates received light over one or more different, respective detection intervals, which are synchronized at different phase angles relative to the carrier frequency, for example at 0°, 90°, 180° and 270°. A processing circuit combines the respective signals from the group of sensing elements in the four detection intervals (referred to as I₀, I₉₀, I₁₈₀ and I₂₇₀, respectively) to extract a depth value, which is proportional to the function tan⁻¹[(I₂₇₀−I₉₀)/(I₀−I₁₈₀)]. The constant of proportionality and maximal depth range depend on the choice of carrier wave frequency. Alternatively, other combinations of phase angles may be used for this purpose, for example six phases that are sixty degrees apart (0°, 60°, 120°, 180°, 240° and 300°), with corresponding adjustment of the ToF computation.

Other iTOF systems use smaller groups of sensing elements, for example pairs of sensing elements that integrate received light in phases 180° apart, or even arrays of sensing elements that all share the same detection interval or intervals. In such cases, the synchronization of the detection intervals of the entire array of sensing elements is shifted relative to the carrier wave of the transmitted beam over successive image frames in order to acquire sufficient information to measure the phase shift of the carrier wave in the received light relative to the transmitted beam. The processing circuit then combines the pixel values over two or more successive image frames in order to compute the depth coordinate for each point in the scene.

Depth maps that are output by the above sorts of iTOF systems suffer from high noise and artifacts due to factors such as variable background illumination, non-uniform sensitivity, and (particularly when signals are acquired over multiple frames) motion in the scene. These problems limit the usefulness of iTOF depth mapping in uncontrolled environments, in which the target scene lighting can vary substantially relative to the intensity of the modulated illumination used in the iTOF measurement, and objects in the target scene may move. These sorts of variations are particularly problematic when they happen during the acquisition of successive frames, which are then combined in order to extract the depth information.

Embodiments of the present invention that are described herein address these problems by averaging iTOF signals spatially over large groups of the sensing elements in an iTOF array to compute the depth coordinates of the points in the target scene. Each such group includes more than four sensing elements, and may comprise, for example, sixteen sensing elements or more. Each sensing element may have at least two acquisition intervals at different phases. In the disclosed embodiments, an illumination assembly directs optical radiation toward the target scene while modulating the optical radiation with a carrier wave having a predetermined carrier frequency (also referred to as the modulation frequency). Objective optics form an image of the target scene on an array of sensing elements, which output respective signals in response to incident optical radiation that is incident on the sensing elements during multiple different detection intervals, which are synchronized with the carrier frequency at different, respective temporal phase angles. Processing circuitry combines the signals output by each group of sensing elements—including more than four sensing elements in each group, as noted above—in order to compute the depth coordinates.

In the embodiments described below, each of the sensing elements integrates and outputs signals with respect to two different detection intervals within each cycle of the carrier wave, for example two detection intervals at temporal phase angles 180° apart, while the detection intervals at the nearest neighbors of each sensing element in the array are shifted by 90°. By summing the signals over the groups of these sensing elements, the processing circuitry is able to capture a depth map of the entire scene in a single image frame. Averaging over large groups of the sensing elements minimizes the impact of differences in response of the sensing elements and other mismatches between the signals, including mismatches between the detection intervals of each sensing element, pixel-to-pixel nonuniformities of the photo-responses of the sensing elements, and temporal variations within the scene itself and/or its lighting environment. In some embodiments, the processing circuitry can also generate a two-dimensional image of the target scene, in which the pixel values correspond to sums of the respective signals output by the sensing elements.

In some embodiments, the sizes of the groups of the sensing elements are not fixed, but rather may be adjusted depending on signal conditions and spatial resolution requirements. For example, the group size may be increased when the signals are noisy, or decreased when finer spatial resolution is desired. The change in group size may be made globally, over the entire array of sensing elements, or locally, such that different numbers of the sensing elements are included in the respective groups for different points in the target scene.

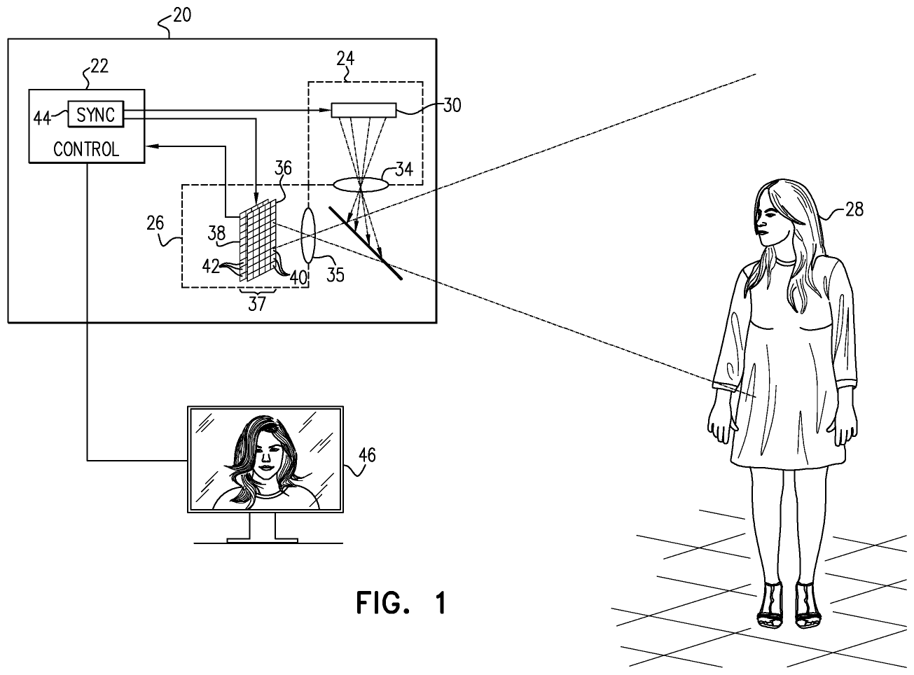

FIG. 1 is a block diagram that schematically illustrates a depth mapping apparatus 20, in accordance with an embodiment of the invention. Apparatus 20 comprises an illumination assembly 24 and a detection assembly 26, under control of processing circuitry 22. In the pictured embodiment, the illumination and detection assemblies are boresighted, and thus share the same optical axis outside apparatus 20, without parallax; but alternatively, other optical configurations may be used.

Illumination assembly 24 comprises a beam source 30, for example a suitable semiconductor emitter, such as a semiconductor laser or high-intensity light-emitting diode (LED), or an array of such emitters, which emits optical radiation toward a target scene 28 (in this case containing a human subject). Typically, beam source 30 emits infrared radiation, but alternatively, radiation in other parts of the optical spectrum may be used. The radiation may be collimated by projection optics 34.

A synchronization circuit 44 modulates the amplitude of the radiation that is output by source 30 with a carrier wave having a specified carrier frequency. For example, the carrier frequency may be 100 MHz, meaning that the carrier wavelength (when applied to the radiation output by beam source 30) is about 3 m, which also determines the effective range of apparatus 20. (Beyond this effective range, i.e., 1.5 m in the present example, depth measurements may be ambiguous due to range folding.) Alternatively, higher or lower carrier frequencies may be used, depending, inter alia, on considerations of the required range, precision and signal/noise ratio.

Detection assembly 26 receives the optical radiation that is reflected from target scene 28 via objective optics 35. The objective optics form an image of the target scene on an array 36 of sensing elements 40, such as photodiodes, in a suitable iTOF image sensor 37. Sensing elements 40 are connected to a corresponding array 38 of pixel circuits 42, which gate the detection intervals during which the sensing elements integrate the optical radiation that is focused onto array 36. Typically, although not necessarily, image sensor 37 comprises a single integrated circuit device, in which sensing elements 40 and pixel circuits 42 are integrated. Pixel circuits 42 may comprise, inter alia, sampling circuits, storage elements, readout circuit (such as an in-pixel source follower and reset circuit, analog to digital converters (pixel-wise or column-wise), digital memory and other circuit components. Sensing elements 40 may be connected to pixel circuits 38 by chip stacking, for example, and may comprise either silicon or other materials, such as III-V semiconductor materials.

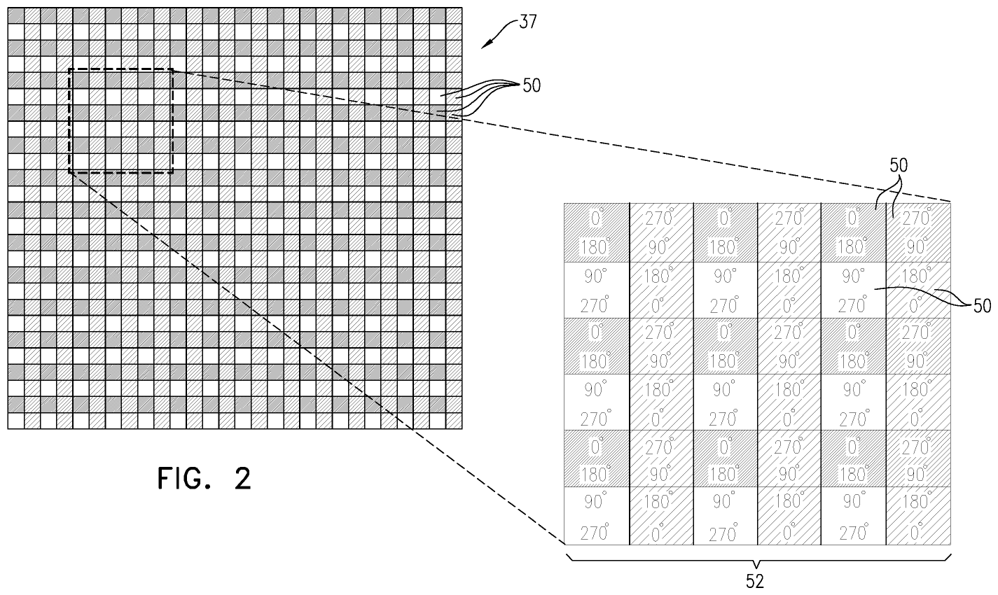

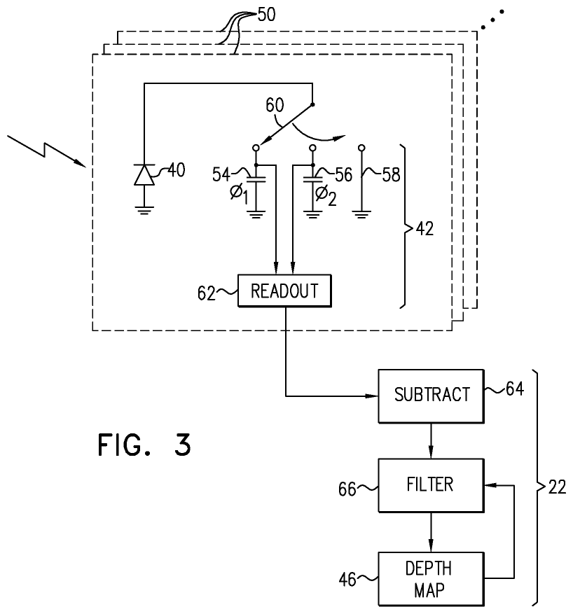

Synchronization circuit 44 controls pixel circuits 42 so that sensing elements 40 output respective signals in response to the optical radiation that is incident on the sensing elements only during certain detection intervals, which are synchronized with the carrier frequency that is applied to beam sources 32. For example, pixel circuits 42 may comprise switches and charge stores that may be controlled individually to select different detection intervals, which are synchronized with the carrier frequency at different, respective temporal phase angles, as illustrated further in FIGS. 2 and 3.

Objective optics 35 form an image of target scene 28 on array 36 such that each point in the target scene is imaged onto a corresponding sensing element 40. To find the depth coordinates of each point, processing circuitry 22 combines the signals output by a group of the sensing elements surrounding this corresponding sensing element, as gated by pixel circuits 42, as described further hereinbelow. Processing circuitry 22 may then output a depth map 46 made up of these depth coordinates, and possibly a two-dimensional image of the scene, as well.

Processing circuitry 22 typically comprises a general- or special-purpose microprocessor or digital signal processor, which is programmed in software or firmware to carry out the functions that are described herein. The processing circuitry also includes suitable digital and analog peripheral circuits and interfaces, including synchronization circuit 44, for outputting control signals to and receiving inputs from the other elements of apparatus 20. The detailed design of such circuits will be apparent to those skilled in the art of depth mapping devices after reading the present description.

FIG. 2 is a schematic frontal view of image sensor 37, in accordance with an embodiment of the invention. Image sensor 37 is represented schematically as a matrix of pixels 50, each of which comprises a respective sensing element 40 and the corresponding pixel circuit 42. Although the pictured matrix comprises only several hundred pixels, in practice the matrix is typically much larger, for example 1000×1000 pixels.

The inset in FIG. 2 shows an enlarged view of a group 52 of pixels 50 (in this example a group of thirty-six pixels). The signals output by the pixels in group 52 are processed together by processing circuitry 22 in order to find the depth coordinate of a point in target scene 28 that is imaged to the center of the group. As noted earlier, the depth coordinates may be computed over larger or smaller groups of pixels, possibly including groups of different sizes in different parts of image sensor 37. To generate the depth map, processing circuitry 22 computes the depth coordinates over multiple groups 52 of this sort, wherein successive groups may overlap with one another, for example in the fashion of a sliding window that progress across the array of pixels.

As shown in the inset, each pixel 50 produces two signal values in response to photocharge generated in the corresponding sensing element 40, with respect to two different detection intervals that are 180° apart in temporal phase within each cycle of the carrier wave. Thus, in the first row of group 52, the odd-numbered pixels include samples at 0° and 180°, giving signals I₀ and I₁₈₀, while the neighboring even-numbered pixels include samples at 270° and 90°, giving signals I₂₇₀ and I₉₀. In the second row, the phases and interleaving of the pixels are reversed, and so forth. (Each pixel circuit 42 contains two sampling taps, as illustrated in FIG. 3, and the phases are “reversed” in the sense that the bin that is used in the pixels in the first row to sample the signals at 0° is used in the second row to sample the signals at 180°, and so forth. Alternatively, other schemes may be used, for example with other phase arrangements and/or with a larger number of taps per pixel. Further alternatively or additionally, rather than acquiring all of the signals in a single frame, the signals may be acquired over multiple sub-frames with different phase relations, for example two sub-frames in which the taps sampling intervals in each pixel are reversed in order to cancel out variations in gain and offset that may occur in each pixel. Even in this case, the principles of the present invention are useful, for example, in mitigating the effects of target motion.)

Processing circuitry 22 calculates, over pixels 50 in group 52, respective sums of the signals output by the sensing elements due to the optical radiation in each of the detection intervals, and then computes the depth coordinates by applying a predefined function to the respective sums. For example, processing circuitry may apply the arctangent function to the quotient of the differences of the sums, as follows:

$$δ = arctan [ \frac{\sum ( {I}_{0} ) - \sum ( {I}_{180} )}{\sum ( {I}_{270} ) - \sum ( {I}_{90} )} ]$$

The depth coordinate at the center of the group is proportional to the value δ and to the carrier wavelength of beam source 30. The sums may be simple sums as in the formula above, or they may be weighted, for example weighted with corresponding coefficients of a filter kernel, which may give larger weights to the pixels near the center of the group relative to those at the periphery.

Alternatively (but equivalently), analog or digital circuitry in each pixel 50 may output the differences of the signal values in each of the two sampling bins in the pixel 50, giving the difference values I₀−I₁₈₀ and I₂₇₀−I₉₀ for the pixels in the first row in FIG. 2, and I₁₈₀−I₀ and I₉₀−I₂₇₀ for the pixels in the second row. Processing circuitry 22 can then apply the following summation formula to find the depth:

$$δ = arctan [ \frac{\sum ( {I}_{0} - {I}_{180} ) - \sum ( {I}_{180} - {I}_{0} )}{\sum ( {I}_{270} - {I}_{90} ) - \sum ( {I}_{90} - {I}_{270} )} ]$$

In addition, processing circuitry 22 may generate a two-dimensional image of target scene 28 using the signals output from each pixel 50. The pixel values in this case will correspond to sums of the respective signals output by each of sensing elements 40, i.e., either I₀+I₁₈₀, or I₂₇₀+I₉₀. These values may similarly be summed and filtered over group 52 if desired.

FIG. 3 is a block diagram that schematically shows details of sensing and processing circuits in depth mapping apparatus 20, in accordance with an embodiment of the invention. Sensing elements 40 in this example comprise photodiodes, which output photocharge to a pair of charge storage capacitors 54 and 56, which serve as sampling bins in pixel circuit 42. A switch 60 is synchronized with the carrier frequency of beam source 30 so as to transfer the photocharge into capacitors 54 and 56 in two different detection intervals that are 180° apart in temporal phase, labeled ϕ₁ and ϕ₂ in the drawing. Pixel circuit 42 may optionally comprise a ground tap 58 or a tap connecting to a high potential (depending on the sign of the charge carriers that are collected) for discharging sensing element 40, via switch 60, between sampling phases. (The pixel carriers and voltage polarities in sensing elements 40 may be either positive or negative.)

A readout circuit 62 in each pixel 50 outputs signals to processing circuitry 22. The signals are proportional to the charge stored in capacitors 54 and 56. Arithmetic logic 64 (which may be part of processing circuitry 22 or may be integrated in pixel circuit 42) subtracts the respective signals from the two phases sampled by pixel 50. A filtering circuit 66 in processing circuitry 22 sums the signal differences over all the pixels 50 in the current group 52, to give the sums Σ(I₀−I₁₈₀), Σ(I₁₈₀−I₀), Σ(I₂₇₀−I₉₀) and Σ(I₉₀−I₂₇₀), as defined above. As noted earlier, processing circuitry 22 may weight the difference values with the coefficients of a suitable filter. Processing circuitry 22 then applies the arctangent formula presented above in order to compute the depth coordinates in depth map 46. Alternatively, the depth coordinates may be derived from the pixel signals using any other suitable formula that is known in the art.

Processing circuitry 22 may modify and adjust the sizes of groups 52 that are used in calculating the depth coordinates at each point in depth map 46 on the basis of various factors. In the example shown in FIG. 3, the depth values in depth map 46 may themselves provide feedback for use in adjusting the group size. For instance, if there is substantial local variance among neighboring depth values, processing circuitry 22 may conclude that the values are noisy, and groups 52 should be enlarged in order to suppress the noise. Alternatively or additionally, other aspects of the depth values and/or the signals output by pixels 50 may be applied in deciding whether to enlarge or reduce the group sizes. Equivalently, processing circuitry 22 may change the coefficients applied by filtering circuit.

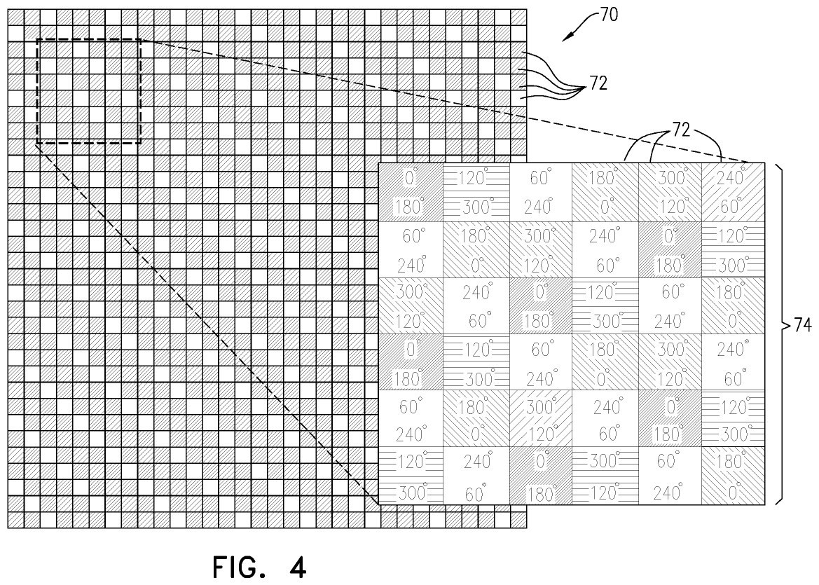

FIG. 4 is a schematic frontal view of an image sensor 70, in accordance with another embodiment of the invention. Image sensor 70 is represented schematically as a matrix of pixels 72, each of which comprises a respective sensing element and the corresponding pixel circuit, as in image sensor 37 in the preceding figures. The inset in FIG. 4 shows an enlarged view of a group 74 of pixels 72 (thirty-six pixels in this example).

In contrast to the preceding embodiments, pixels 72 are output their respective signals with respect to detection intervals that are separated by 60° within each cycle of the carrier wave. Thus, in the present case the depth coordinate at the center of the group is proportional to the value δ given by the following formula:

$$δ = arctan ( \sqrt{3} \frac{\sum ( {I}_{3 oo} - {I}_{120} ) + \sum ( {I}_{24 o} - {I}_{60} )}{\sum ( {I}_{3 oo} - {I}_{120} ) - \sum ( {I}_{24 o} - {I}_{60} ) + 2 \sum ( {I}_{0} - {I}_{180} )} )$$

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. Apparatus for optical sensing, comprising:
an illumination assembly, which is configured to direct optical radiation toward a target scene while modulating the optical radiation with a carrier wave having a predetermined carrier frequency;
a detection assembly, which is configured to receive the optical radiation that is reflected from the target scene, and comprises:
an array of sensing elements, which are configured to output respective signals in response to the optical radiation that is incident on the sensing elements during each of a plurality of detection intervals, which are synchronized with the carrier frequency at different, respective temporal phase angles; and
objective optics, which are configured to form an image of the target scene on the array; and
processing circuitry, which is configured to process the signals output by the sensing elements in order to compute depth coordinates of the points in the target scene by combining the signals output by respective groups of more than four of the sensing elements.

2. The apparatus according to claim 1, wherein each of the sensing elements is configured to output the respective signals with respect to two different detection intervals within each cycle of the carrier wave.

3. The apparatus according to claim 2, wherein for each of the sensing elements, the respective temporal phase angles of the two different detection intervals are 180° apart and are shifted by 90° relative to a nearest neighboring sensing element in the array.

4. The apparatus according to claim 1, wherein the sensing elements are configured to output the respective signals with respect to detection intervals that are separated by 60° within each cycle of the carrier wave.

5. The apparatus according to claim 1, wherein the processing circuitry is configured to calculate, over the sensing elements in each of the respective groups, respective sums of the signals output by the sensing elements due to the optical radiation in each of the detection intervals, and to compute the depth coordinates by applying a predefined function to the respective sums.

6. The apparatus according to claim 1, wherein the processing circuitry is further configured to generate a two-dimensional image of the target scene comprising a matrix of image pixels having respective pixel values corresponding to sums of the respective signals output by each of the sensing elements.

7. The apparatus according to claim 1, wherein the respective groups comprise at least sixteen of the sensing elements.

8. The apparatus according to claim 1, wherein the processing circuitry is configured to adjust a number of the sensing elements in the groups.

9. The apparatus according to claim 8, wherein the processing circuitry is configured to adjust the number of the sensing elements in the groups responsively to the signals output by the sensing elements.

10. The apparatus according to claim 9, wherein the processing circuitry is configured to detect a level of noise in the signals output by the sensing elements, and to modify the number of the sensing elements in the groups responsively to the level of the noise.

11. The apparatus according to claim 8, wherein the processing circuitry is configured to include different numbers of the sensing elements in the respective groups for different points in the target scene.

12. A method for optical sensing, comprising:
directing optical radiation toward a target scene while modulating the optical radiation with a carrier wave having a predetermined carrier frequency;
forming an image of the target scene on an array of sensing elements, which output respective signals in response to the optical radiation that is incident on the sensing elements during each of a plurality of detection intervals, which are synchronized with the carrier frequency at different, respective temporal phase angles; and
processing the signals output by the sensing elements in order to compute depth coordinates of the points in the target scene by combining the signals output by respective groups of more than four of the sensing elements.

13. The method according to claim 12, wherein each of the sensing elements outputs the respective signals with respect to two different detection intervals within each cycle of the carrier wave, wherein for each of the sensing elements, the respective temporal phase angles of the two different detection intervals are 180° apart and are shifted by 90° relative to a nearest neighboring sensing element in the array.

14. The method according to claim 12, wherein the sensing elements output the respective signals with respect to detection intervals that are separated by 60° within each cycle of the carrier wave.

15. The method according to claim 12, wherein processing the signals comprises calculating, over the sensing elements in each of the respective groups, respective sums of the signals output by the sensing elements due to the optical radiation in each of the detection intervals, and computing the depth coordinates by applying a predefined function to the respective sums.

16. The method according to claim 12, and comprising generating a two-dimensional image of the target scene comprising a matrix of image pixels having respective pixel values corresponding to sums of the respective signals output by each of the sensing elements.

17. The method according to claim 12, wherein the respective groups comprise at least sixteen of the sensing elements.

18. The method according to claim 12, wherein processing the signals comprises adjusting a number of the sensing elements in the groups.

19. The method according to claim 18, wherein the number of the sensing elements in the groups is adjusted responsively to the signals output by the sensing elements.

20. The method according to claim 18, wherein the number of the sensing elements in the groups is adjusted to include different numbers of the sensing elements in the respective groups for different points in the target scene.
